(19) United States
(12) Patent Application Publication
(10) Pub. No.: US 2007/0133606 A1
(43) Pub. Date: Jun. 14, 2007

(54) Data packaging and transport method and apparatus

(76) Inventors: Mark E. Boduch, Geneva, IL (US); Charles H. Daugherty, Naperville, IL (US)

Correspondence Address: DAVIS & ASSOCIATES, P.O. BOX 1093, DRIPPING SPRINGS, TX, 78620, US

(21) Appl. No.: 11/298,923

(22) Filed: Dec. 10, 2005

(51) Int. Cl. H04J 3/00; H04L 12/56

(52) U.S. Cl. 370/476; 370/395.51

(57) ABSTRACT

A method includes receiving a first frame of m n-bit bytes. A second frame is constructed at least in part from the first frame. The second frame has j k-bit bytes, wherein k>n, wherein j is selected for a pre-determined p such that p·j·k mod n=0. A plurality (p) of the second frames may be k-bit byte multiplexed to form a composite frame.

### TECHNICAL FIELD

This invention relates to the field of communications. In particular, this invention is drawn to methods of supporting multiple data formats using a common encapsulating carrier for transport.

### BACKGROUND

Some telecommunication applications rely upon high bandwidth digital multiplexing techniques for data transport in a network. Due to the variety of network layer protocols, interfaces, and mediums that facilitate communication between nodes of the network, standards have been developed to support the multiplexing of a wide variety of data formats and data rates onto a common high bandwidth signal.

Two related standards governing digitally multiplexed signals in an optical network are Synchronous Optical Network (SONET) and Synchronous Digital Hierarchy (SDH). SONET is a North American version of a suite of standards published by the American National Standards Institute (ANSI). SDH is an international version of a suite of standards published by the International Telecommunications Union (ITU).

SONET and SDH support a hierarchy of digital data rates. Slower rate bitstreams are combined into a faster rate bitstream by round-robin sampling from the slower bit streams. The bitstreams include payload data and overhead data. With the appropriate overhead data, SONET and SDH can support synchronous or asynchronous data transport using a synchronous high bandwidth carrier. SONET and SDH are frequently touted as offering standardization, reliability, flexibility, quality of service, scalability, and manageability for network operations.

One disadvantage of the SONET and SDH framing protocols is a lack of lower level error checking. Although parity bits can be introduced to detect errors for each byte of a frame, the introduction of additional bits creates byte sizes that may not be readily compatible with components such as field programmable gate arrays (FPGAs) or application specific integrated circuits (ASIC) that are designed to handle a standard-sized byte.

### SUMMARY

In accordance with the present invention, one method includes receiving a first frame of m n-bit bytes. A second frame is constructed at least in part from the first frame. The second frame has j k-bit bytes, wherein k>n and j is selected for a pre-determined p such that p·j·k mod n=0.

Another method includes receiving a plurality (p) of frames of a first type, each having m n-bit bytes. A second type of frame having j k-bit bytes is constructed from each frame of the first type, wherein k>n, wherein p·j·k mod n=0.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of an STS-1 frame.

FIG. 2 illustrates an optical path and sources of overhead.

FIG. 3 illustrates one embodiment of a method of constructing an STS-3 frame.

FIG. 4 illustrates one embodiment of a System Data Format (SDF) frame.

FIG. 5 illustrates one embodiment of a method of constructing a frame of j k-bit bytes from m n-bit bytes.

FIG. 6 illustrates one embodiment of an enhanced SDF (ESDF) frame.

FIG. 7 illustrates intact STS-1 mapping to an ESDF frame.

FIG. 8 illustrates one embodiment of a VT 1.5 mapped STS-1.

FIG. 9 illustrates one embodiment of mapping a VT 1.5 mapped STS-1 to an ESDF frame.

FIG. 10 illustrates an alternative embodiment of VT 1.5 mapping from an STS-1 to an ESDF frame.

FIG. 11 illustrates one embodiment of an ESDF-48 frame.

FIG. 12 illustrates one embodiment of a 9-bit byte view of an ESDF-48 frame overhead.

FIG. 13 illustrates one embodiment of an 8-bit byte view of an ESDF-48 frame overhead.

FIG. 14 illustrates one embodiment of a method of generating a composite frame.

FIG. 15 illustrates one embodiment of a method of constructing a composite frame.

FIG. 16 illustrates one embodiment of a cross-connect.

### DETAILED DESCRIPTION

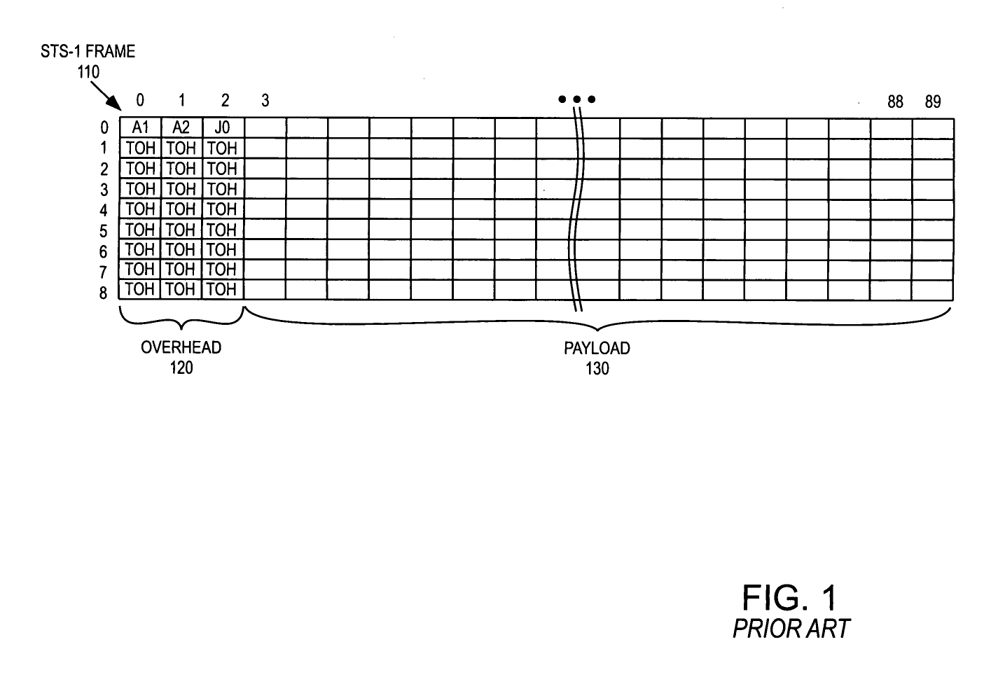

FIG. 1 illustrates an embodiment of a synchronous transport signal level 1 (STS-1) frame. The STS-1 frame supports 810 bytes (9 rows of 90 bytes). The frame is communicated serially proceeding row-to-row from top-to-bottom and left-to-right.

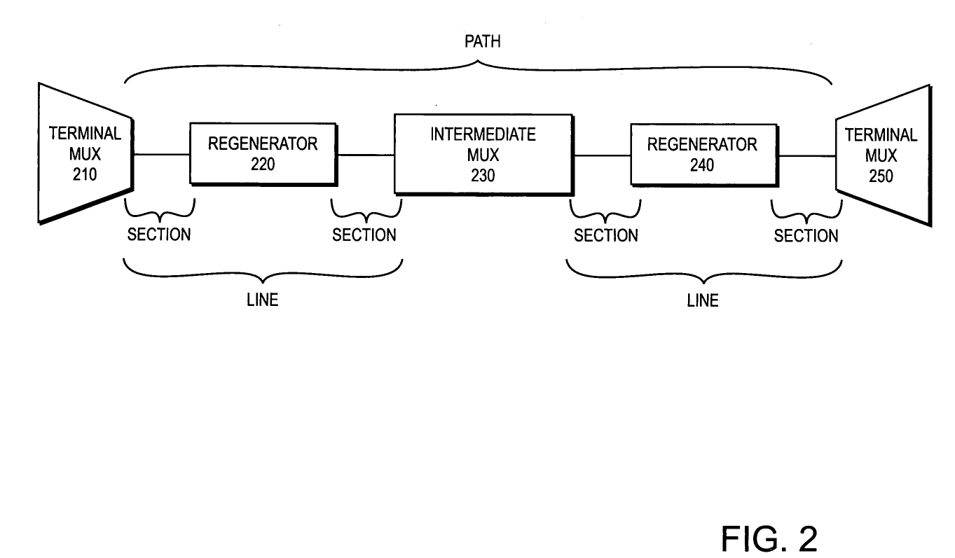

The first three bytes of each row are overhead and the remaining columns represent payload data. Overhead can include section, path, and line overhead. Line and section overhead may be combined as “transport overhead” (TOH). FIG. 2 illustrates an optical network line including a number of various network elements 210, 220, 230, 240, and 250. Section overhead relates to the communication between adjacent network elements such as terminal multiplexer 210 and regenerator 220. Line overhead relates to the communication between consecutive multiplexers such as terminal multiplexer 210 and intermediate multiplexer 230 or intermediate multiplexer 230 and terminal multiplexer 250. Path overhead relates to the end-to-end communication between terminal multiplexers 210, 250. The differing levels of overhead enable framing, multiplexing, status, trace, and performance monitoring at various levels of the network.

SONET provides for a scaling of the STS-1 frame in order to support greater transport bandwidths (i.e., line rates). “STS” is the designation for the electrical domain “synchronous transport signal” while “OC” is the designation for the optical domain “optical carrier” signal. Faster line rates are integer multiples (q) of the STS-1 (OC-1) line rate designated as STS-q (OC-q). When q>1, the scaled frame will also be referred to as a composite frame. The frames are transmitted every 125 microseconds (μs). Thus an STS-1 frame corresponds to a 51.84 Mbps line rate. An STS-3 corresponds to a 155.5 Mbps line rate.

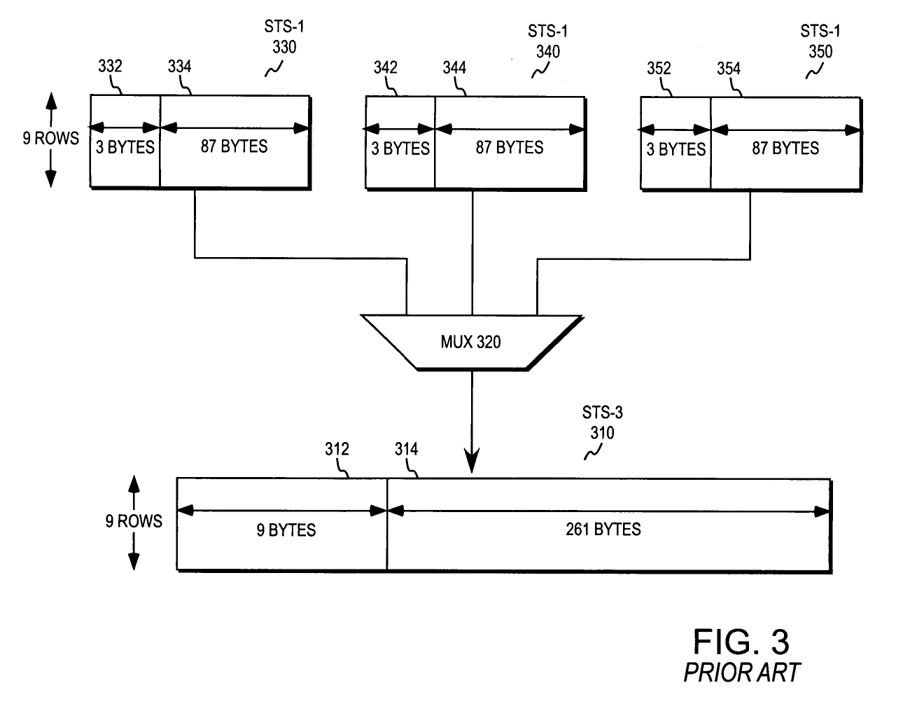

FIG. 3 illustrates one embodiment of the creation of a composite frame such as an STS-3 frame 310. Each STS-1 frame has an overhead portion (332, 342, 352) and-a payload portion (334, 344, 354). Multiplexer 320 combines STS-1 frames 330, 340, and 350 into an STS-3 frame. The STS-3 frame has 3 times the overhead and 3 times the payload of the STS-1 frame. The overhead data 332, 342, 352 is grouped together as STS-3 310 overhead 312 and the payload data 334, 344, 354 is grouped together as STS-3 310 payload 314.

Interoperability with SONET-based networks is desirable due to the prevalence of such networks. However, SONET frames and protocols are not necessarily best-suited for some operations. Some network elements may repackage SONET frames to better facilitate various functions within their proprietary network elements. SONET frames, for example, are based upon 8-bit bytes or “octets”. Although SONET provides for some error detection, SONET does not provide error detection on a row, column, or byte basis. The inclusion of a parity bit for each byte permits error detection on an individual byte basis. The parity bit, however, results in modification of the octets to 9-bit bytes.

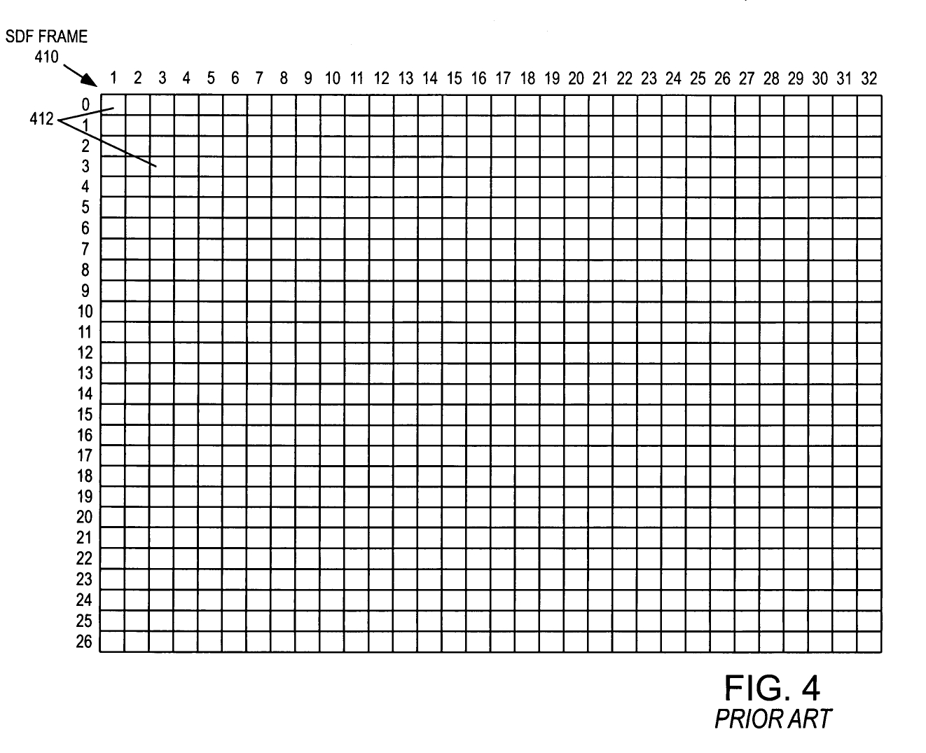

A System Data Format (SDF) frame 410 is illustrated in FIG. 4. Every byte 412 of the frame is a 9-bit byte that supports parity detection at a byte level. In order to aid in framing a frame with 9-bit bytes, some of the parity bits may be altered to provide framing information. This distributed framing approach increases the complexity that is required for frame detection circuitry. The complexity is exacerbated when the SDF frame is multiplexed for higher line rates. This distributed framing approach is thus generally not well-suited for scalability. Moreover, the 9-bit bytes are not immediately compatible with standard components based upon either octet or 10 bit architectures, for example. An improved frame format supports handling by equipment designed for different byte sizes. The improved frame format is selected to facilitate handling of an improved composite frame formed by a multiplexing operation such as that illustrated in FIG. 3 with respect to the STS-1 frame.

In general, a frame having m n-bit bytes is converted to a frame having j k-bit bytes, wherein k>n. In one embodiment n=8 and k=9. In one embodiment the additional k−n bits per byte are parity bits. The variable j is judiciously selected for a pre-determined p such that p·j·k mod n=0, where p represents the number of frames present in the composite frame to be processed and m, n, j, k, and p are all integers. The term “mod” refers to the modulo function. If x mod y=0, then x is an integer multiple of y.

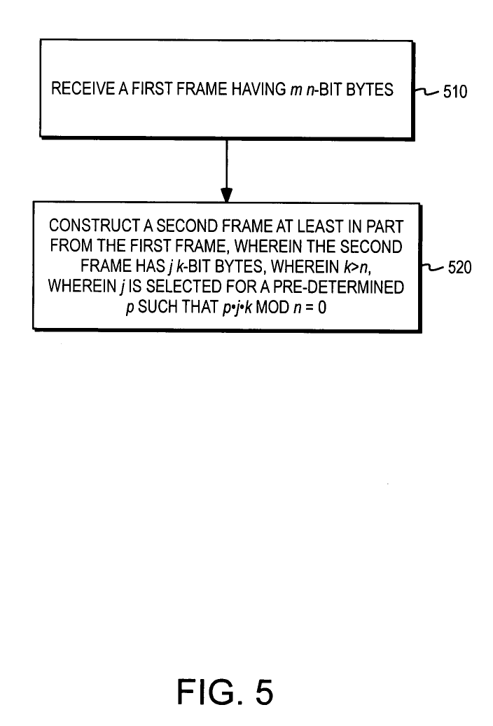

FIG. 5 illustrates the process. A first frame having m n-bit bytes is received in step 510. A second frame is constructed at least in part from the first frame in step 520. The second frame has j k-bit bytes, wherein k>n. To ensure that the composite frame formed from a plurality (p) of byte-multiplexed second frames may be processed in the n-bit domain, j is chosen for a pre-determined p such that p·j·k mod n=0. Although not explicitly illustrated, an optical-to-electrical domain conversion may take place prior to steps 510 or 520 such that the construction of the second frame is performed in the electrical domain even if the first frame is optically communicated. Similarly, an electrical-to-optical conversion may be performed after step 520 to permit subsequent optical communication of the second frame.

The construction of the second frame may involve the addition of k-bit bytes, the addition of parity bit(s), or bit-padding where appropriate. In one embodiment, j≠m. In one embodiment, j>m. Bit-padding entails inserting 1s or 0s as padding to convert an n-bit byte to a k-bit byte.

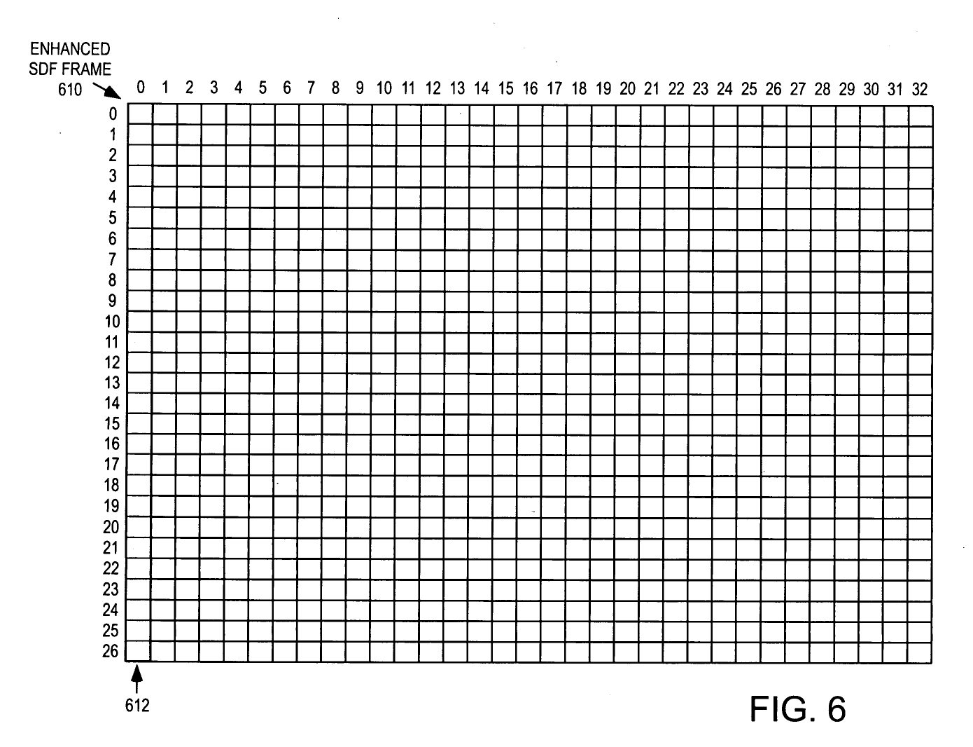

FIG. 6 illustrates one embodiment of an enhanced SDF (ESDF) frame 610. The ESDF is distinguished from the SDF frame by the addition of a column 612 of 9-bit bytes for a total of 33 columns of 27 rows of 9-bit bytes.

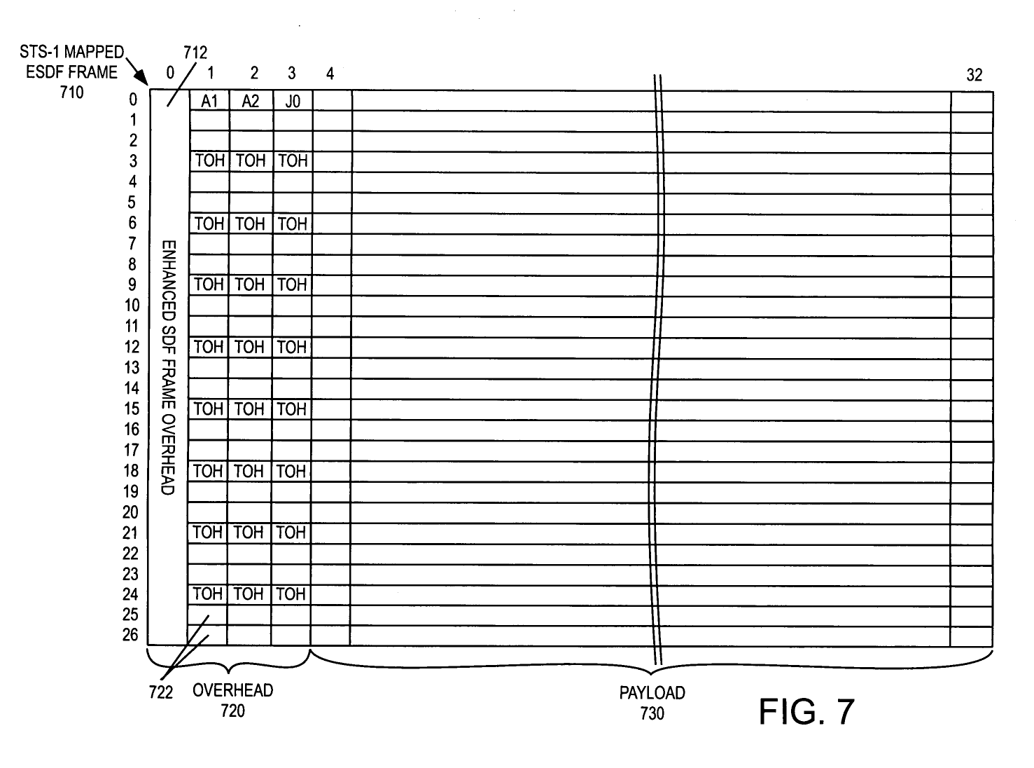

FIG. 7 illustrates the mapping of an STS-1 to an ESDF frame 710. The added column 712 permits the introduction of application-specific fields. This format is compatible with off-the-shelf SONET framing devices for retiming SONET payloads because the mapping preserves the SONET serial byte order. The overhead columns 720 have been padded with “don't care” bytes (e.g., 722) to complete the columns and aid in preservation of the SONET serial byte order. The “don't care” bytes do not affect the payload columns 730. The “don't care” bytes should not be confused with the pre-existing “fixed stuff” bytes of the intact STS-1 mapping.

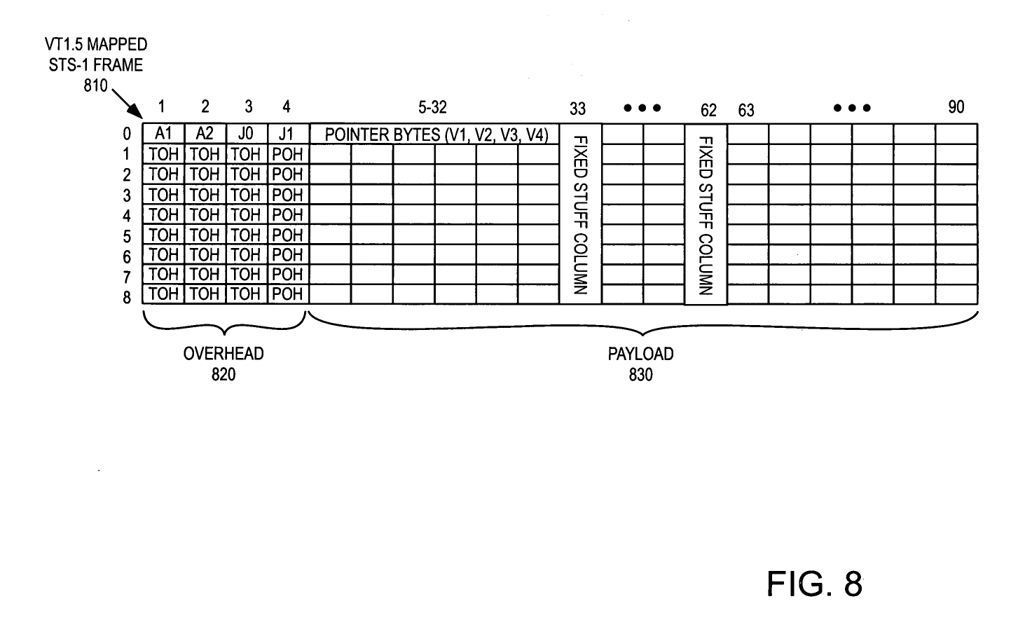

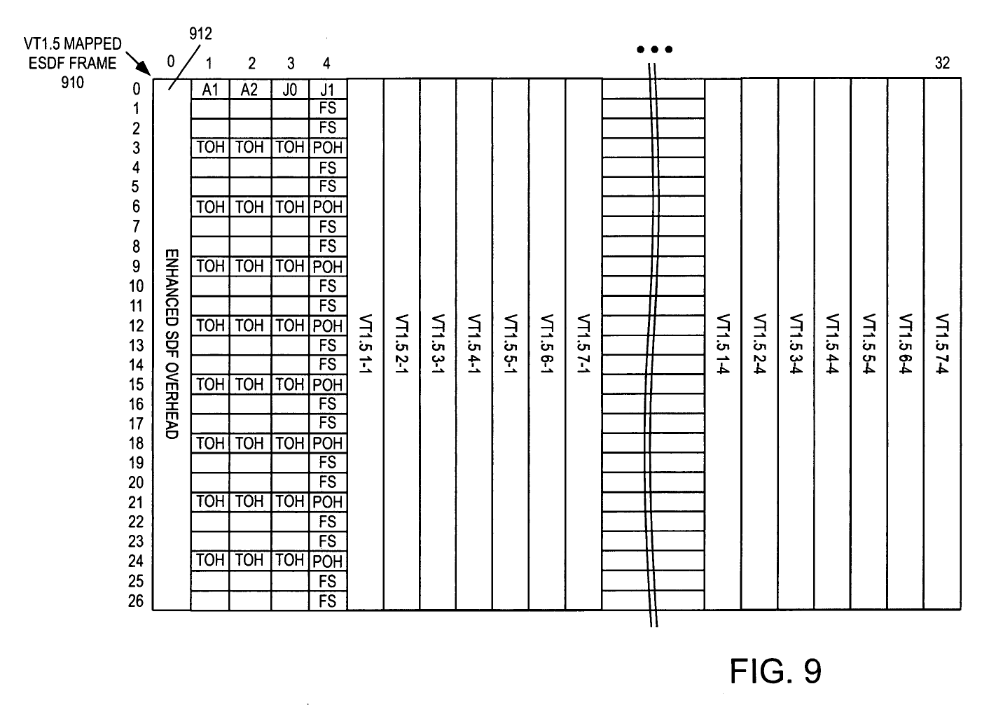

FIG. 8 illustrates one embodiment of a VT 1.5 mapped STS-1 frame 810. “POH” refers to path overhead. The VT 1.5 mapped STS-1 may be mapped to an ESDF frame 910 as illustrated in FIG. 9.

The mapping may vary depending upon the path. Consider a path that incorporates a VT 1.5 time-slot switch. Given that an STS-1 signal switched at the VT 1.5 level is section, line, and path terminated, the bytes contained within columns 1-4 of FIG. 9 do not have to be passed through the switching fabric. These columns may therefore be used for other purposes such as time-slot expansion. Thus there are an additional four VT 1.5 columns that may be used for time slot expansion.

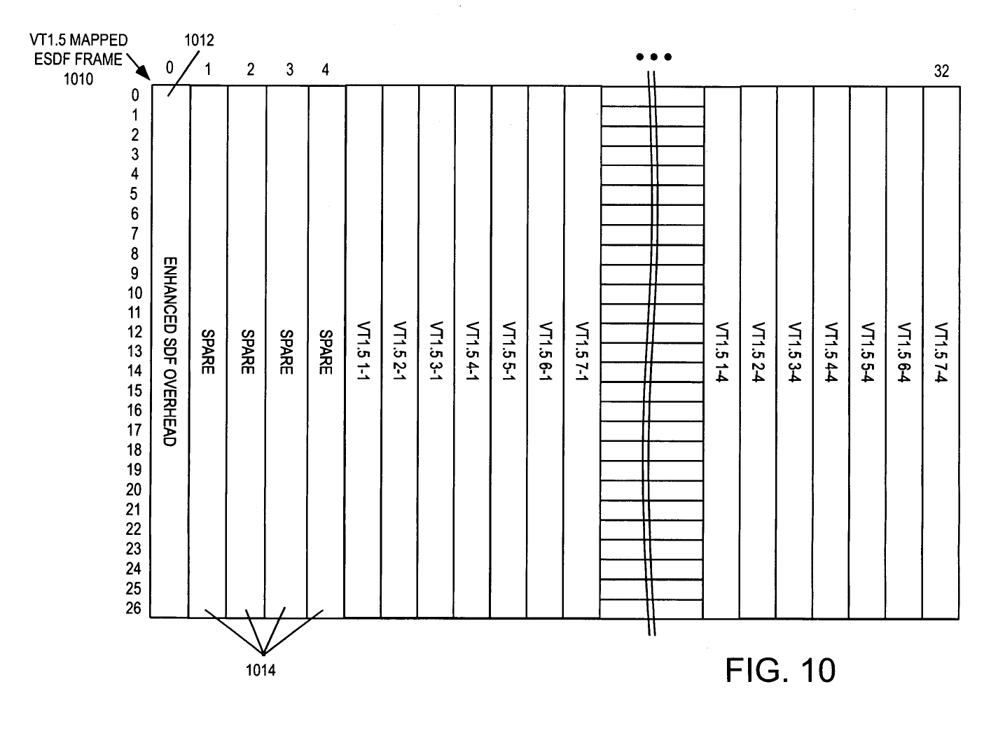

FIG. 10 illustrates an alternative embodiment of a VT 1.5 mapped STS-1 that is mapped to ESDF frame 1010. Four additional VT 1.5 columns 1014 have been made available without disturbing the ESDF overhead column 1012.

Due to the properties of the ESDF frame and the location of the don't care bytes, the process of mapping an STS-1 to an ESDF frame is independent of the content of the STS-1. Comparing FIGS. 2, 7, 8, 9, and 10, for example, the mapper maps the 810 bytes of the STS-1 the same way into the ESDF regardless of whether the STS-1 contains an STS-1 SPE (i.e., path overhead plus payload) or a VT 1.5 mapped STS-1.

The mapper proceeds as follows: after the first ESDF overhead byte, the first 32 bytes of the STS-1 are mapped into the ESDF frame, followed by another byte of ESDF overhead and three “don't care” bytes. The mapper then maps the next 29 bytes from the STS-1 frame followed by another byte of ESDF overhead and three “don't care” bytes. The mapper continues with another 29 bytes from the STS-1 frame followed by another byte of ESDF overhead followed by 32 more bytes from the STS-1 frame, etc.

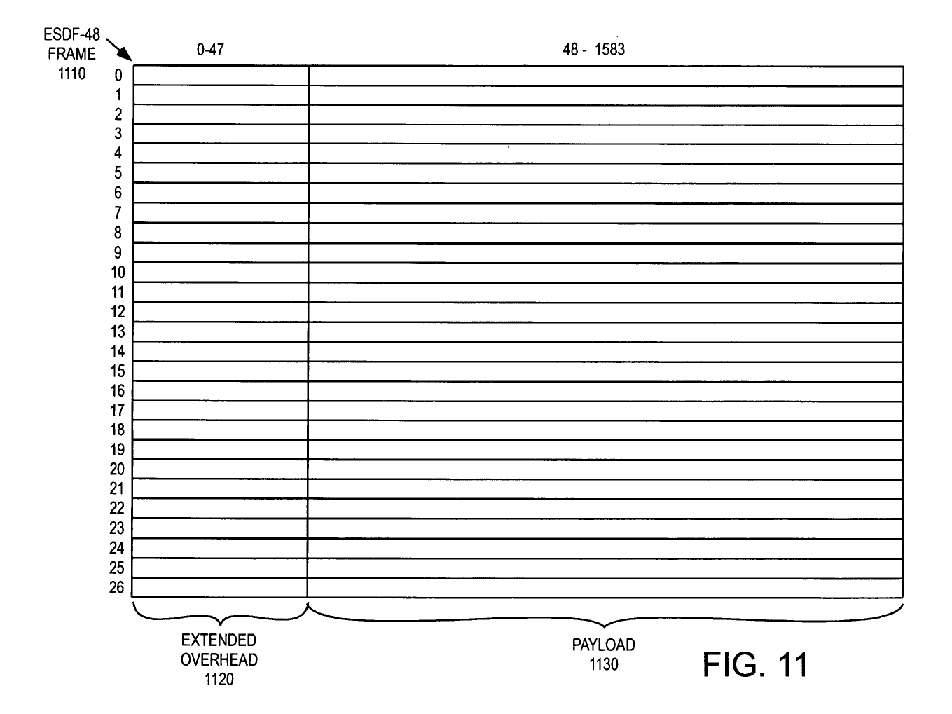

A given ESDF frame may be byte-multiplexed with other ESDF frames to accommodate higher line rates. In FIG. 11, for example, forty-eight (p=48) ESDF frames are 9-bit byte multiplexed to form an ESDF-48 frame 1110. The illustrated ESDF-48 frame 1110 comprises 1584 columns of twenty-seven rows of 9-bit bytes for a total of 42,768 9-bit bytes. There are 48 columns of “extended” overhead 1120 that were not available with an SDF-48. The remaining 1536 columns are ESDF-48 payload data 1130.

Assuming a 125 μs frame rate, a single ESDF frame with 33 columns of 27 9-bit bytes has a transmission rate of 64.152 Mbps in contrast to the 62.208 Mbps of the SDF frame or the 51.84 Mbps of an STS-1 frame. The ESDF-48 frame is communicated at the SONET frame rate. Thus each ESDF-48 is transmitted every 125 μs for a transmission rate of 3.079296 Gbps. Although the examples are drawn to an ESDF-48, other multiples are possible. An ESDF-96, for example, will have a 6.158592 Gbps transmission rate.

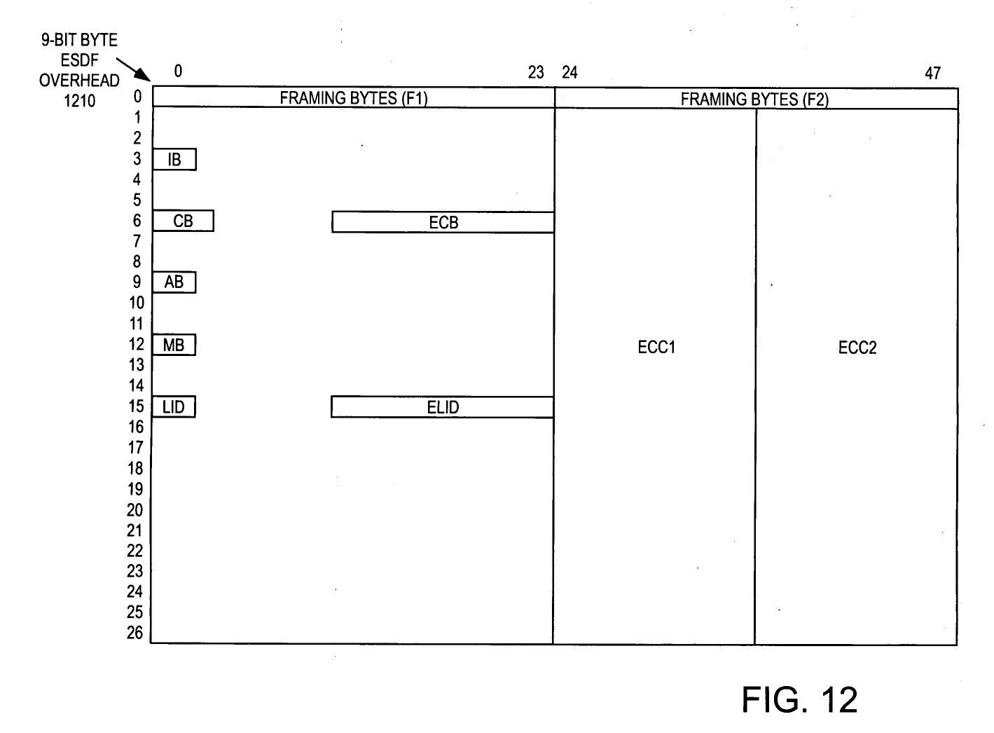

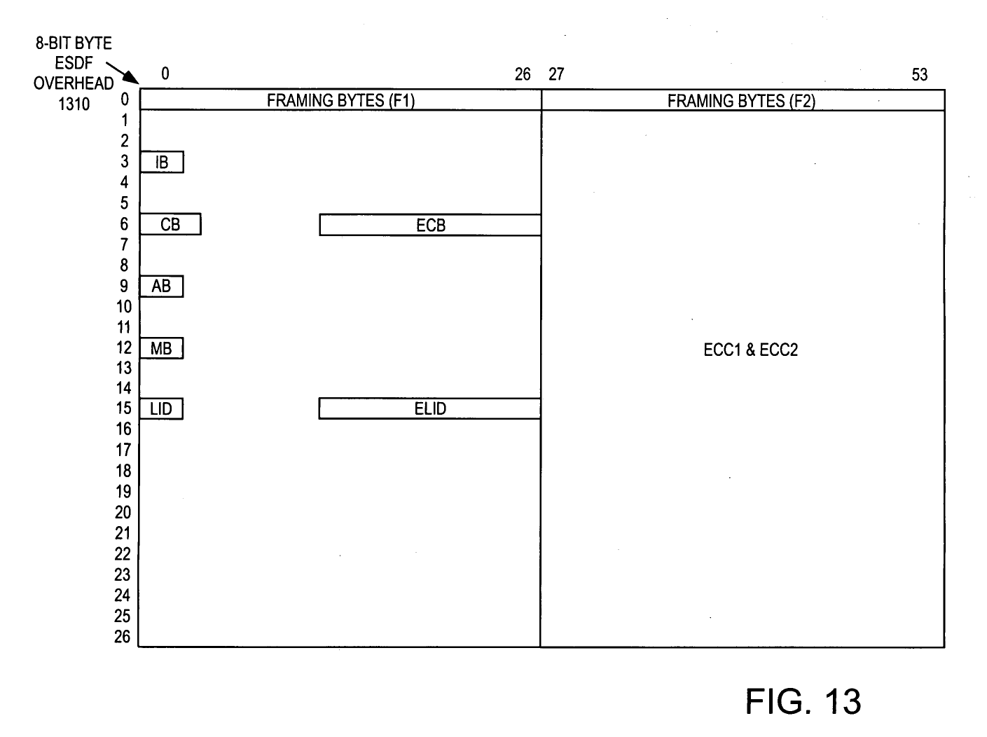

The extended overhead columns 1120 provide an opportunity to introduce a number of additional application-specific fields. Although the existence, location, and purpose of some of these fields may vary from application to application, ten examples (FB, IB, AB, CB, ECB, MB, LID, ELID, ECC1, ECC2) are described with respect to the 9-bit byte view of extended overhead columns 1210 illustrated in FIG. 12 and the 8-bit byte view of extended overhead columns 1310 illustrated in FIG. 13.

FIG. 13 illustrates one embodiment of an 8-bit view of the ESDF-48 extended overhead 1310. The extended overhead 1310 comprises 54 columns of 8-bit bytes. The ESDF-48 extended overhead columns are largely manipulated as 8-bit bytes. The use of a composite frame that is readily divisible by n=8 or k=9 permits n-bit processing of the overhead and k-bit processing of the payload. In order for the overhead to be readily processed in the n-bit domain, p, k, and n should be selected to meet the additional constraint of p·k mod n=0.

In one embodiment, the first 9-bit byte of the overhead column of each ESDF frame is reserved for a framing byte “FB”. Referring to FIG. 13, however, an 8-bit view is used when populating the framing bytes for the ESDF-48 frame. This is because processing blocks such as serial-to-parallel converters, parallel-to-serial converters, and framers are typically configured to process integer numbers of 8-bit byte data. There are 432 bits in each row of the ESDF overhead within an ESDF-48 frame. Each row of the ESDF overhead of the ESDF-48 frame contains fifty-four 8-bit bytes. The first 27 of these 8-bit bytes are given a first value (A1=0xF6). Thus “F1” represents 27 octets having the value 0xF6. The second group of twenty-seven 8-bit bytes of the ESDF-48 frame are given a second value (A2=0x28). Thus “F2” represents 27 octets having the value 0x28. This results in a 54 byte (8-bit) section of the first row having a plurality of A1 bytes (collectively “F1”) that sharply transition into a plurality of A2 bytes (collectively “F2”) to aid in the identification of the ESDF-48 frame boundaries. Unlike the distributed framing approach of the SDF frame, framing for the ESDF-q frame is easily determined by identifying a boundary regardless of the value of q thus resulting in a frame that is much better suited for scalability.

Composite frames are typically serialized for transmission over an electrical or optical link at a link source point and then de-serialized at a link destination point. The ESDF-48 framing bytes are inserted into the ESDF-48 frame prior to leaving an ESDF-48 link source point. When ESDF-48 frames are de-serialized at an ESDF-48 link destination point, the framing bytes are discarded following the framing process. Therefore, when ESDF-48 serial channels are used to pass data between switching stages, framing bytes received by a second switch from a first switch are not “passed through” the second switch. Thus although other extended overhead bytes may be passed through without modification, the framing bytes are inserted (i.e., replaced) at each ESDF-48 link source point.

The integrity byte (IB) occupies the first 8 bits of row 3 of the ESDF-48 frame. The IB byte has a function similar to the B1 byte of a SONET frame. The integrity byte is computed from an 8-bit view of the previous ESDF-48 frame. The integrity byte is used to verify the integrity of the previous ESDF-48 frame. The full-frame 8-bit view of the ESDF-48 frame has 1782 columns and 27 rows of octets. If all 1782 columns were stacked, the result would be a stack of 48,114 bytes (8 bits wide). Each bit position of the IB byte is calculated from a column of 48,114 bits in the same bit position. The most significant bit, for example, of the IB byte may be computed from the most significant bits of all 42,768 bytes. In one embodiment, the value is “1” if the number of “1”s is odd and “0” if the number of “1”s is even. In one embodiment, IB is calculated by exclusive ORing all the remaining bits of each byte of the ESDF-48 frame.

The communication bytes (CB) may be used by various applications. In the illustrated embodiment, the CB uses the first 16 bits of row 6 of the ESDF-48 frame overhead. The 17^{th} and 18^{th} bits are not used.

The extended communication bytes (ECB) occupy columns 8 through 23 of row 6 of the ESDF-48 frame (for a total of 144 bits in 16 9-bit bytes). In an 8-bit byte viewpoint, the ECB occupies columns 9 through 26 of row 6 (for a total of 144 bits in 18 8-bit bytes). Although the ECBs are application dependent, the ECBs begin and end on boundaries shared by both 8-bit and 9-bit views. Thus at least one application-specific field both starts and ends at an n-bit byte boundary and a k-bit byte boundary.

Assume that the most significant bit of the first byte of the ESDF-48 frame is bit number 1 and the position of each subsequent bit is counted from this most significant bit (msb). Let x indicate the starting position (i.e., the position of the msb) of the ECB field and y indicate the ending position (i.e., the least significant bit (lsb)) of the ECB field, wherein y>x.

In one embodiment, the ECB field starts on a k-bit byte boundary that is also an n-bit byte boundary such that
x mod k=1; and
x mod n=1

In one embodiment, the ECB field ends at a k-bit byte boundary that is also an n-bit byte boundary such that
y mod k=0; and

y mod n=0

In order for the ECB field to start and end on boundaries shared by both n- and k-bit bytes, the ECB field must have a length L such that
L mod k=0; and
L mod n=0

Thus in one embodiment, an application-specific field is defined within the ESDF-48 overhead such that the field 1) starts at a location that is both an n-bit boundary and a k-bit boundary, or 2) ends at a location that is both an n-bit boundary and a k-bit boundary, or 3) both.

The alarm byte (AB) field occupies the first 8 bits of row 9 of the ESDF-48 frame overhead illustrated in FIGS. 12-13. The 9^{th} bit of row 9 is not used. The alarm byte is used to indicate ESDF-48 link and system level alarms. Different bits may be used to indicate different types of alarms. For example, a far-end link framing alarm (Y-FRM), a far-end multiframe align alarm (Y-MFA), and a switch network alignment alarm (SN_AIS) are identified by the AB field in one embodiment.

The multiframe byte (MB) field occupies the first 8 bits of row 12 of the ESDF-48 frame overhead. The 9^{th} bit is not used. A multiframe is a group of ESDF-48 frames. In one embodiment, forty-eight ESDF-48 frames can be grouped together to form a multiframe. For this example, the period associated with the multiframe is six milliseconds (ms). The MB is used to indicate the phase of a multiframe transmission and may be used by a receiver to locate the ESDF multiframe. In one embodiment, for the case of a forty-eight frame multiframe, the MB sequences from 0 to 47 so that the correct ESDF-q frame is identified from a series of ESDF-q frames.

The link id (i.e., identification) byte (LID) field occupies the first 16 bits of row 15 of the ESDF-48 frame overhead. Bits 17 and 18 are not used. The LID field is used to validate individual cable interconnections within a given system that utilizes ESDF-48 links.

The extended link id byte (ELID) field occupies columns 8-23 of row 15 of the ESDF-48 frame overhead. As with the LID field, the ELID field is used to validate individual cable interconnections within a given system.

Embedded communication channels (ECC) are also supported. The ESDF-48 frame illustrated in FIGS. 12 and 13 supports a first (ECC1) and a second (ECC2) embedded communication channel. These channels occupy rows 1-26 of columns 24-47 (9-bit view) or columns 27-53 (8-bit view) of the ESDF-48 frame overhead. The embedded communications channels permit the communication of local area network (LAN) control information from an ESDF-48 link source point to an ESDF48 link destination point.

The ESDF and the ESDF-q provide an envelope that is relatively easy to construct for a wide variety of input frame types. Due to the straightforward mapping, the contents of the envelope may similarly be readily extracted from the envelope. The use of a common envelope, however, facilitates packaging and handling during transport.

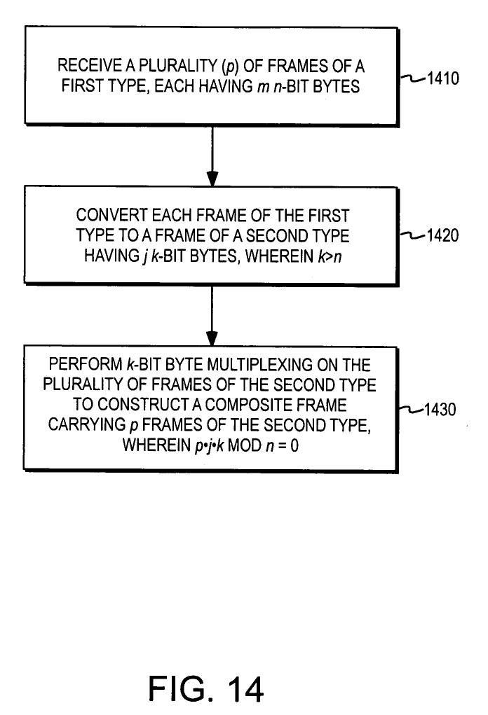

FIG. 14 illustrates one embodiment of a method for generating a composite frame such as the ESDF-q frame. In step 1410, a plurality (p) of frames of a first type is received. Each frame of the first type has m n-bit bytes. In step 1420, each frame of the first type is converted to a frame of a second type. The second type of frame has j k-bit bytes, wherein k>n.

In step 1430, a composite frame is constructed by k-bit byte multiplexing the plurality of frames of the second type. The composite frame carries p frames of the second type, wherein p·j·k mod n=0.

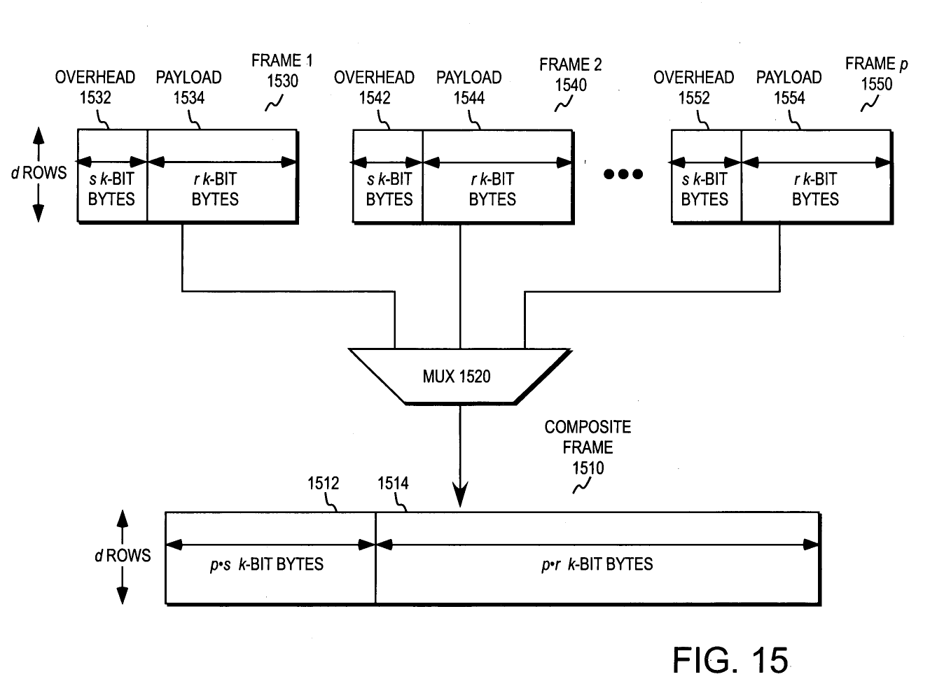

FIG. 15 illustrates one embodiment of a multiplexing operation for forming a composite frame such as the ESDF-q frame. Each of the plurality (p) of frames 1530, 1540, 1550 consists of j k-bit bytes. Although the frames may represent a serial data stream, they are organized as s columns 1532, 1542, 1552 of overhead bytes and r columns 1534, 1544, 1554 of payload bytes in the illustrated embodiment for ease of visualization. The columns consist of d rows of k-bit bytes. Thus j=d(s+r). Multiplexer 1520 performs k-bit byte multiplexing to form composite frame 1510.

Composite frame 1510 consists of p·j k-bit bytes that may be visually organized as p·s adjacent columns of overhead and p·r adjacent columns of payload, wherein each column consists of d rows of k-bit bytes. Although the constraint p·j·k mod n=0 ensures that the composite frame ends on both an n-bit and k-bit boundary, the stronger constraint of p·k mod n=0 ensures that the boundary between the overhead and payload columns lies on both a k-bit and an n-bit boundary.

After the composite frame is constructed, the composite frame may be electrically or optically communicated within the various portions of the optical network. In one embodiment, the composite frame is serially communicated within the optical network. The composite frame, for example, may be serially communicated by row proceeding from the top left of the first row and ending with the bottom right of the last row. In one embodiment, the serial communication uses a most significant bit order when transmitting each byte.

In one embodiment, n=8 and k=9, however, bytes of other numbers of bits may be utilized. Importantly the second type of frame may comprise a differing number of bytes than the first type of frame. Thus in one embodiment, j≠m. The ESDF frame previously described introduced an additional column of bytes suitable for application-specific functions. Thus in one embodiment, j>m.

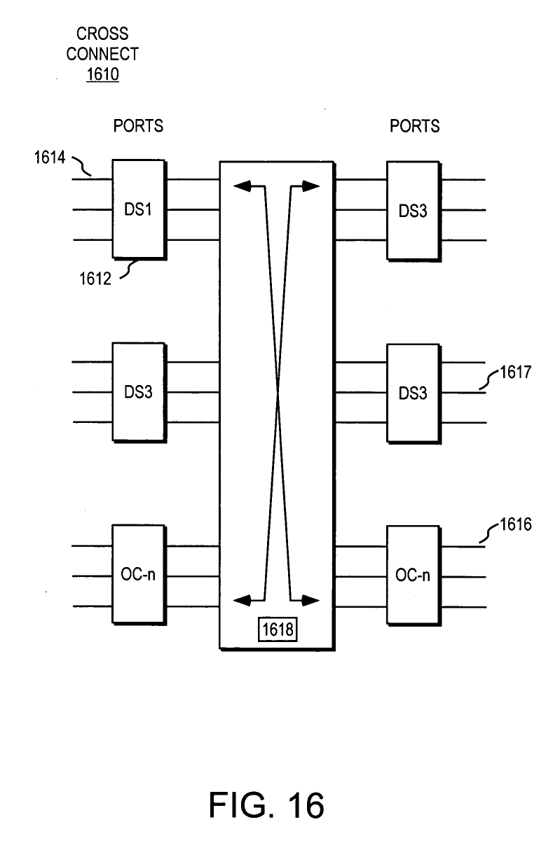

FIG. 16 illustrates one embodiment of an apparatus performing the methods set forth in FIGS. 5 and 14. A cross-connect 1610 has a plurality of ports 1612 coupled to paths 1614, 1616, 1617 for communicating digital data. The paths may be electrical or optical. Some paths 1614 may be electrical for example while others 1616 are optical.

The cross-connect connects a channel or group of channels from one path (e.g., 1614) to a selected channel or group of channels of another path (e.g., 1616 or 1617) thus enabling aggregation of lower rate electrical or optical lines to higher rate electrical or optical lines or distribution of data via higher or lower rate data paths as appropriate. The cross-connect may include a processor 1618 for performing the methods set forth in FIGS. 5 and 14.

The cross-connect may receive data in a frame of a first type from any line. The first type of frame includes m n-bit bytes. The cross-connect processor 1618 constructs a second type of frame at least in part from the first type of frame, wherein the second type frame has j k-bit bytes, wherein k>n. The value for j is selected for a pre-determined p such that p·j·k mod n=0. Either the processor or other circuitry such as the multiplexer illustrated in FIG. 14 can perform k-bit byte multiplexing on a plurality p of the second type of frame to generate a composite frame carrying p frames of the second type. The variables m, n, j, k, and p represent integer values. The composite frame facilitates processing the overhead as n-bit bytes while handling payload as k-bit bytes using different views as long as p, k, and n are selected to meet the stronger constraint of p·k mod n=0.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method comprising:
a) receiving a first frame of m n-bit bytes; and
b) constructing a second frame at least in part from the first frame, wherein the second frame has j k-bit bytes, wherein k>n, wherein j is selected for a pre-determined p such that p·j·k mod n=0.

2. The method of claim 1 wherein step b) further comprises converting each n-bit byte of the first frame to a k-bit byte.

3. The method of claim 2 wherein each n-bit byte is padded to form a corresponding k-bit byte.

4. The method of claim 2 wherein for at least one selected k-bit byte at least one of the additional k−n bits is a parity bit.

5. The method of claim 1 wherein j≠m.

6. The method of claim 1 wherein j>m.

7. The method of claim 1 wherein p·k mod n=0.

8. The method of claim 1 further comprising:
c) serially communicating the second frame along at least one of an electrical path and an optical path.

9. The method of claim 1, wherein construction of the second frame is independent of a content of the first frame.

10. A method comprising:
a) receiving a plurality (p) of frames of a first type, each having m n-bit bytes; and
b) constructing a second type of frame having j k-bit bytes from each frame of the first type, wherein k>n, wherein p·j·k mod n=0.

11. The method of claim 10 further comprising:
c) performing k-bit byte multiplexing on the plurality of frames of the second type to form a composite frame carrying p frames of the second type.

12. The method of claim 11 further comprising:
d) replacing a plurality of the k-bit bytes with n-bit framing bytes for aiding with frame alignment.

13. The method of claim 11 further comprising:
d) replacing a plurality of the k-bit bytes with a plurality of n-bit bytes defining an application-specific field.

14. The method of claim 13 wherein the application-specific field begins on both a k-bit byte boundary and an n-bit byte boundary.

15. The method of claim 13 wherein the application-specific field ends on both a k-bit byte boundary and an n-bit byte boundary.

16. The method of claim 13 wherein the application-specific field begins on a starting boundary that is both a k-bit byte boundary and an n-bit byte boundary, wherein the application-specific field ends on an ending boundary that is both a k-bit byte boundary and an n-bit byte boundary.

17. The method of claim 11 wherein p·k mod n=0.

18. The method of claim 11 further comprising:
d) serially communicating the composite frame along at least one of an electrical path and an optical path.

19. The method of claim 10 wherein construction of the second type of frame is independent of a content of any of the p frames of the first type.

20. The method of claim 10 wherein j≠m.

21. The method of claim 10 wherein j>m.

22. An apparatus, comprising:
a processor coupled to receive a plurality (p) of frames of a first type, each having m n-bit bytes, wherein the processor constructs a second type of frame having j k-bit bytes from each frame of the first type wherein k>n, wherein p·j·k mod n=0.

23. The apparatus of claim 22 further comprising:
a multiplexer, wherein the multiplexer performs k-bit byte multiplexing on the plurality of frames of the second type to generate a composite frame carrying p frames of the second type.

24. The apparatus of claim 23 wherein p·k mod n=0.

25. The apparatus of claim 22 coupled to a plurality of data communication paths, wherein the apparatus forms a cross-connect.
